(19) United States
(12) Patent Application Publication
(10) Pub. No.: US 2024/0142568 A1
(43) Pub. Date: May 2, 2024

(54) COEXISTENCE BETWEEN COMMUNICATIONS IN A MOBILE COMMUNICATIONS SYSTEM AND A RADAR APPLICATION

(71) Applicant: Telefonaktiebolaget LM Ericsson (publ), Stockholm (SE)

(72) Inventors: Magnus Sandgren, STAFFANSTORP (SE); Ashkan Kalantari, MALMÖ (SE); Andres Reial, HÖLLVIKEN (SE); Gang Zou, LUND (SE); Henrik Sjöland, LUND (SE)

(21) Appl. No.: 18/281,126

(22) PCT Filed: Mar. 11, 2021
(86) PCT No.: PCT/EP2021/056194

§ 371 Date: Sep. 8, 2023

(51) Int. Cl. G01S 7/02; G01S 7/03; G01S 13/22; G01S 13/526; H04L 5/14

(52) U.S. Cl. CPC G01S 7/0235; G01S 7/034; G01S 13/225; G01S 13/526; H04L 5/1469

(57) ABSTRACT

A radar sensing function is performed in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction, and in which each transmitted symbol from a plurality of transmitted symbols has a corresponding cyclic prefix that is transmitted immediately before the corresponding transmitted symbol, and that is a repetition of an end part of the corresponding transmitted symbol. Information about a path delay between the mobile communication device and a receiver is used as one of one or more bases to determine a timing of a radar operation window having a duration that is shorter than a duration of a cyclic reception window of the receiver and comprising a radar signal transmission time and a radar backscatter reception period. The determined timing of the radar operation window is configured to cause the radar signal, when transmitted from the mobile communication device at the determined radar signal transmission time, to arrive at the receiver during a portion of the cyclic prefix reception window of the receiver. The radar signal is transmitted at the determined time.

### BACKGROUND

The present invention relates to technology that enables a mobile communication device to carry out a radar application with little to no interference to communications being carried out in a mobile communication system in which the mobile communication device is operating.

There is a need for applications in mobile phones and other modem-equipped devices to be aware of objects and events in their surroundings. These needs can be at least partly satisfied by means of radar sensing. Moreover, information derived from radar sensing may be combined (e.g., as in sensor fusion) with data from other sensors (e.g., cameras) to provide an even greater understanding of the device's operating environment.

Radar functionality can be integrated into a communication device such as 3GPP phone (herein denoted as “user equipment”, or more simply, “UE”) either by using the device's radiofrequency (RF) transceiver as a radar transmitter/receiver or by equipping the device with a dedicated radar transceiver. However, equipping a device to utilize radar in a region served by a mobile communication system presents a problem because a radar signal generally occupies a wide frequency bandwidth such that the radar signal's presence may introduce RF interference towards the base station (BS) or the device's neighboring UEs.

The work described in International Patent Application Publication No. WO2019/233830 A1, December 2019 (E. Bengtsson, “Coexistence of Radar Probing and Wireless Communication), considers the use of beam sweeping to identify one or more beams for wireless communication between two devices. In addition, it includes radar probing in directions based on one or more beam sweeps. The technology checks whether the wireless device can probe with spatial restriction or not. The UE measures the spectral power levels on various beams to avoid interference between communication and radar probing. Radar probing restrictions can be imposed with respect to one or more of power level, time, frequency, and spatial direction.

U.S. Pat. No. 10,439,743 B2, issued in October 2019 to M.I.T. Vargas et al (“System, Method, and Apparatus for Managing Co-Channel Interference”) describes an approach for managing the interference between two fixed wireless links or a fixed wireless link and a radio access network (RAN). This work proposes the use of coordination between the nodes to sense the interference when there is no communication. One use case can be the coexistence of 5G and fixed wireless services.

U.S. Patent Application Publication No. US 2018/0199377, published on July 2018 (A. Sanderovich et al. “Co-Existence Of Millimeter Wave Communication And Radar”), discusses radar and communication coexistence, and for this purpose discusses reserving the channel, or sending the radar signal when there is no communication.

In another paradigm, U.S. Patent Application Publication No. US2019/0293781 published in September 2019 (T. Bolin et al.) proposes using orthogonal resources for simultaneous radar and data communication. The publication mentions that the resource elements can be frequency, time, spatial dimension, or code dimension.

There is therefore a need for technology that addresses the above described and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) that performs a radar sensing function in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction, and in which each transmitted symbol from a plurality of transmitted symbols has a corresponding cyclic prefix that is transmitted immediately before the corresponding transmitted symbol, and that is a repetition of an end part of the corresponding transmitted symbol. Information about a path delay between the mobile communication device and a receiver is used as one of one or more bases to determine a timing of a radar operation window having a duration that is shorter than a duration of a cyclic reception window of the receiver and comprising a radar signal transmission time and a radar backscatter reception period. The determined timing of the radar operation window is configured to cause the radar signal, when transmitted from the mobile communication device at the determined radar signal transmission time, to arrive at the receiver during a portion of the cyclic prefix reception window of the receiver. The radar signal is transmitted at the determined radar signal transmission time.

In another aspect of some but not necessarily all embodiments consistent with the invention, determining the timing of the radar operation window comprises using an uncertainty associated with the information about the path delay as one of the bases to determine the timing of the radar operation window.

In yet another aspect of some but not necessarily all embodiments consistent with the invention, a transmission power of the radar signal is adjusted based on a radar transmission timing uncertainty.

In still another aspect of some but not necessarily all embodiments consistent with the invention, determining the timing of the radar operation window comprises using an uncertainty associated with a placement of the cyclic prefix reception window of the receiver or of a symbol reception window of the receiver.

In another aspect of some but not necessarily all embodiments consistent with the invention, determining the timing of the radar operation window comprises using information about a level of multi-path delay spread experienced at the receiver as one of the bases to determine the timing of the radar operation window.

In yet another aspect of some but not necessarily all embodiments consistent with the invention, transmission power of the radar signal is adjusted based on the level of radar signal multi-path delay spread at the receiver.

In still another aspect of some but not necessarily all embodiments consistent with the invention, the receiver is a network node receiver and the determined time causes the transmitted radar signal to arrive during the portion of the cyclic prefix reception window of the network node receiver.

In yet another aspect of some but not necessarily all embodiments consistent with the invention, it is detected that a power level to be applied when transmitting the radar signal is above a threshold power level associated with an automatic gain control process of the receiver, and in response to the detecting, one or more mitigating actions are performed to mitigate an effect that transmitting the radar signal would have on the automatic gain control process of the receiver.

In another aspect of some but not necessarily all embodiments consistent with the invention, determining the timing of the radar operation window comprises obtaining information about a timing of a symbol reception window at the receiver; and deriving the timing of the radar operation window and a length of the radar operation window from the received information about the timing of the symbol reception window at the receiver and one or more values of timing uncertainty about a beginning portion of the cyclic prefix reception window of the receiver and an end portion of the cyclic prefix reception window of the receiver.

In yet another aspect of some but not necessarily all embodiments consistent with the invention, network-provided information about radio resources of one or more other mobile communication devices is used to determine a radar signal filter that will mitigate interference from the one or more other mobile communication devices when a backscatter signal of the radar signal is received.

In still another aspect of some but not necessarily all embodiments consistent with the invention, a mobile communication device timing capability level is reported to a network node. In another aspect of some but not necessarily all embodiments consistent with the invention, a length of the radar operation window in proportion to a level of timing accuracy of the mobile communication device is determined.

In yet another aspect of some but not necessarily all embodiments consistent with the invention, the receiver is a receiver of another mobile communication device and the determined time causes the transmitted radar signal to arrive during the portion of the cyclic prefix reception window of said another mobile communication device.

In still another aspect of some but not necessarily all embodiments consistent with the invention, a value of downlink propagation delay from a network node to said another mobile communication device and a value of radar propagation delay between the mobile communication device and said another mobile communication device are used as at least two bases to determine the timing of the radar operation window.

In another aspect of some but not necessarily all embodiments consistent with the invention, a level of radar signal transmission power is used as one of said bases to determine the timing of the radar operation window.

In yet another aspect of some but not necessarily all embodiments consistent with the invention, a transmission power level of the transmitted radar signal is adjusted in dependence on a radar propagation delay between the mobile communication device and said another mobile communication device.

In still another aspect of some but not necessarily all embodiments consistent with the invention, a value of downlink propagation delay from the network node to the mobile communication device is used as the value of downlink propagation delay from the network node to said another mobile communication device.

In another aspect of some but not necessarily all embodiments consistent with the invention, the value of downlink propagation delay from the network node to said another mobile communication device is obtained from said another mobile communication device.

In yet another aspect of some but not necessarily all embodiments consistent with the invention, the value of downlink propagation delay from the network node to said another mobile communication device is obtained from the network node.

In still another aspect of some but not necessarily all embodiments consistent with the invention, a direction of a transmission beam is tuned based on a timing of a downlink cyclic prefix period of said another mobile communication device.

In another aspect of some but not necessarily all embodiments consistent with the invention, determining the timing of the radar operation window comprises selecting a cyclic prefix transmission window of a symbol transmitted by a network node during one of the downlink time slots when a radar surveillance range is below a predetermined distance threshold; and selecting a cyclic prefix reception window of a symbol received by the network node during one of the uplink time slots when the radar surveillance range is above the predetermined distance threshold.

In yet another aspect of some but not necessarily all embodiments consistent with the invention, an instruction that prohibits performance of a radar operation is received from a network node.

### BRIEF DESCRIPTION OF THE DRAWINGS

The objects and advantages of the invention will be understood by reading the following detailed description in conjunction with the drawings in which:

FIG. 1A illustrates a situation in which a radar enabled mobile communication device operates in the vicinity of two other mobile communication devices, with all three being served by a base station.

FIG. 1B is a chart showing the relationship between subcarrier spacing and cyclic prefix during uplink TDD operation, as defined by the 3GPP NR standards.

FIG. 1C illustrates some of the timing aspects that are relevant to the herein-described technology.

FIG. 2 illustrates how timing error margins can be applied to the radar signal timing in order to avoid overlapping with the uplink transmission of another mobile communication device.

FIG. 3 is, in one respect, a flowchart of actions performed by the system in accordance with a number of embodiments consistent with the invention.

FIG. 4 is a signaling diagram illustrating how a radar enabled mobile communication device interacts with a base station with respect to a radar operation.

FIG. 5A depicts a radar enabled mobile communication device in a cell that also includes first and second other communication devices, with all three of the devices being served by a base station.

FIG. 5B is a chart showing the relationship between subcarrier spacing and cyclic prefix during downlink TDD operation, as defined by the 3GPP NR standards.

FIG. 5C illustrates some of the timing aspects that are relevant to the herein-described technology with respect to radar operation during the downlink phase of TDD operation.

FIG. 6 is a timing diagram showing how timing error margins can be applied to the radar signal timing in order to avoid overlapping with the downlink transmission of the base station when received by another mobile communication device.

FIG. 7 is, in one respect, a flowchart of actions performed by a radar enabled mobile communication device in accordance with a number of embodiments consistent with the invention.

FIG. 8 is a block diagram of an exemplary controller of a system in accordance with some but not necessarily all exemplary embodiments consistent with the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

An aspect of the herein-described technology pertains to coexistence between radar operations and communication within a shared geographical region.

In an aspect of embodiments consistent with an aspect of some embodiments consistent with the invention, a framework is provided in which a UE times transmission of a radar signal based on a cyclic prefix period of an Orthogonal Frequency Division Multiplexed (OFDM) symbol.

In a further aspect of some but not necessarily all embodiments consistent with the invention, improved coexistence between 5G New Radio (NR) technology and radar signals during these communication phases is achieved by providing different frameworks for respective uplink and downlink cyclic prefix periods.

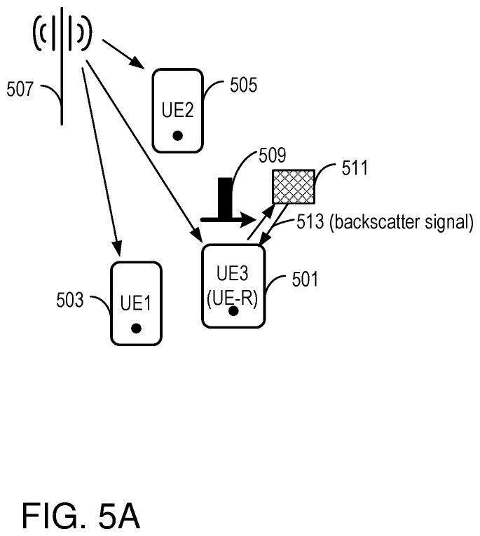

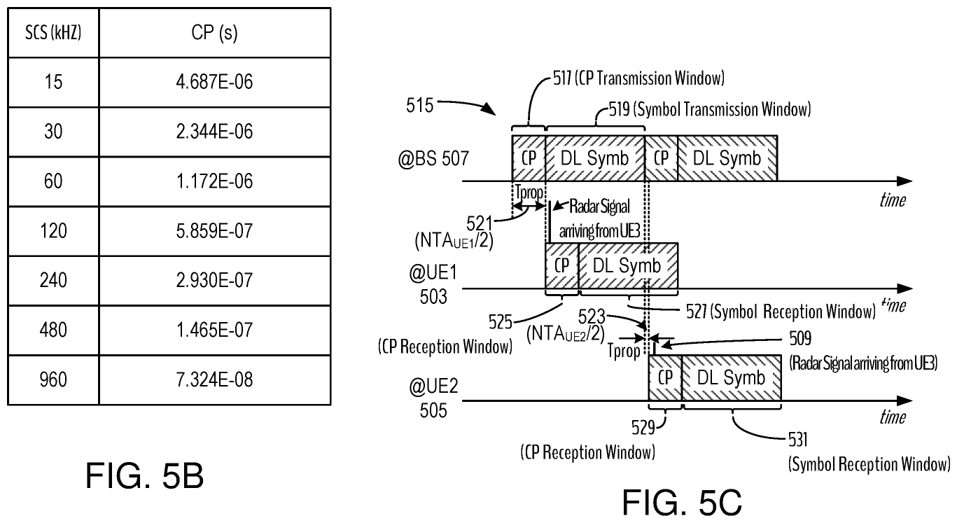

These and other aspects will now be described in greater detail in connection with the figures. 5G NR uses the mmWave frequencies (i.e., Frequency Range 2 (FR2), which includes frequency bands from 24.25 GHz to 52.6 GHz), in Time Division Duplex (TDD) mode for communication. Although using this frequency range opens a wide spectrum, it is highly susceptible to blockage and attenuation. Hence, the UE and BS need to select suitable communication beams in order to ensure reliable communications.

UEs can also use the mmWave frequencies to transmit radar signals. However, depending on whether the radar system is operating in the uplink or downlink phases of the TDD communication protocol, this may cause interference toward the BS (uplink) or toward other UEs (downlink). As used herein, the term “radar-enabled UE (abbreviated as “UE-R”) is used to denote a UE with radar capability.

The radar operation of the UE may cause interference in the following phases of the mmWave TDD:
1. Radar operation during uplink phase of TDD: The radar-enabled UE transmits radar signals that may interfere with the uplink signals of other UEs (e.g., control/data/Sounding Reference Symbols (SRS)) when they arrive at the BS during the uplink phase of mmWave TDD.
2. Radar operation during downlink phase of TDD: The radar-enabled UE transmits radar signals that may interfere with the downlink signal sent by the BS toward the surrounding UEs during the downlink phase of TDD. The level of interference experienced by any one of these other UEs depends on the RF pathloss and beam direction between the radar-enabled UE and the other UEs. Depending on the distance and orientation of other UEs, the radar-enabled UE may mitigate this interference by changing the transmit power, direction and/or duration of the radar signal adaptively.

If the radar operation is ill-timed, its simultaneous use of allocated time/frequency resources of the communicating system can interfere with it. Accordingly, in an aspect of embodiments consistent with the invention, the radar enabled-UE can sense the environment during a suitable portion of a cyclic prefix (CP) segment of the OFDM symbols that avoids the radar and communication interfering in time. The following discussion discloses techniques for placing the radar sensing within suitable portions of the CP period of the uplink and downlink OFDM symbols that avoid radar and communication interference without compromising the inter-symbol interference (ISI) mitigation function of the CP for communicating UEs.

Using the CP period for radar sensing in this manner reduces the likelihood of interference to the uplink (UL) receiver in the absence of reserved dedicated resources, and therefore enables radar operation while efficiently using the available radio spectrum. Similar improvements are achieved with respect to downlink (DL) receivers of other devices when radar operation is performed during a DL phase of TDD operation.

The discussion will now focus on embodiments in which radar operation is performed during UL transmission times of TDD.

When communications take place on a non-dispersive communication channel, the cyclic prefix (CP) is redundant, and is therefore discarded by the UL receiver (e.g., a base station receiver). For lightly or more dispersive channels, the CP fulfills an intersymbol interference (ISI) mitigation function and provides error robustness with respect to inaccuracies in the timing advance (TA) estimation of the BS and in the transmit timing execution at the UE. In NR-compliant systems, the length of the CP depends on Sub Carrier Spacing (SCS) being used and is shorter at mmWave. Certain first symbols in a regular communication slot have a longer CP period compared to other symbols and are more favorable for radar sensing, although use of these particular CP periods is not an essential aspect of inventive embodiments. This opens an opportunity to perform radar sensing during a CP period. In one embodiment, when a BS finds its UL multi-path delay spread is below a certain threshold (meaning that a sufficient portion of the received CP will represent redundant information and be discarded anyway), it may inform radar enabled UEs under its coverage about the possibility of using the CP associated with an UL symbol for radar sensing.

The uplink timing estimates are imperfect due to errors in the TA control loop and in the UE's transmit timing. The CP covers this and includes an extra margin for channel delay spread. When the channel is more dispersive, it becomes more difficult to estimate the correct starting time of the symbol and the BS may capture a part of the CP in order to be able to decode the received symbol. But this still leaves part of the CP available for radar sensing. The BS knows the available period and can inform the radar-enabled UE. It is noted that an extended CP has been used in earlier systems (e.g., for MBSFN) but in NR systems is only defined for at 60 kHz SCS and comes with overhead.

The network can use the uplink timing measurements of UL communication signals from the radar-enabled UE and/or of the received radar transmission from the radar-enabled UE and the TA control loop to guide the radar-enabled UE to time transmission of the radar signal so that the BS receives the radar transmission at an uplink timing that is within the cyclic prefix (CP) of the OFDM symbol and outside the BS assigned reception window. In some but not necessarily all embodiments consistent with the invention, further mitigation of interference can be achieved by having the network allocate time/frequency and spatial resources for use by radar sensing during uplink and downlink phases of TDD operation.

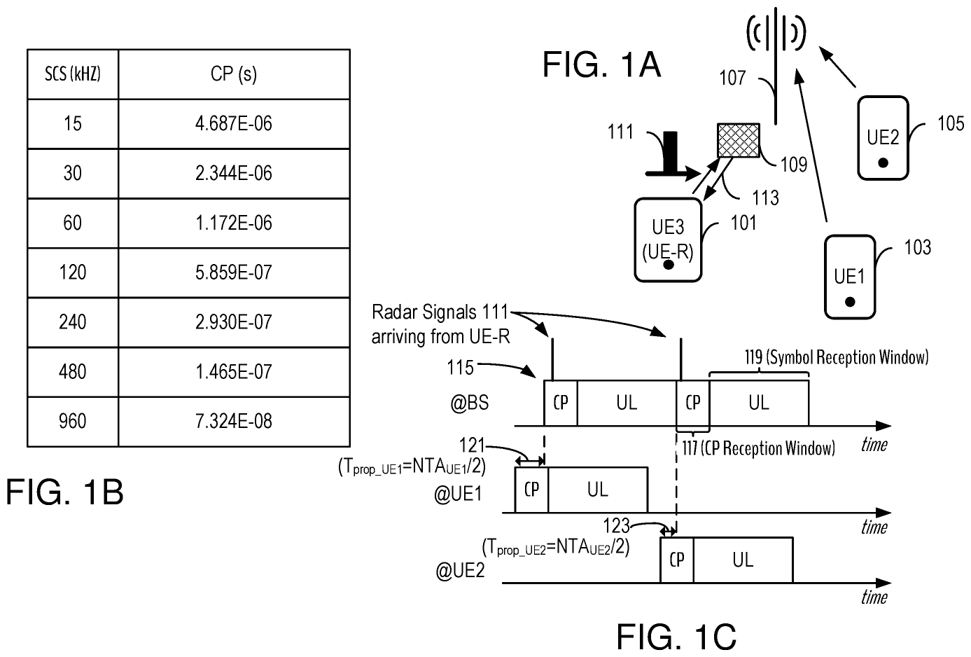

This aspect of inventive embodiments is now described in further detail with reference first to FIGS. 1A, 1B, and 1C. FIG. 1A illustrates a situation in which a UE-R 101 operates in the vicinity of two other UEs 103, 105, with all three being served by a base station 107. The UE-R 101 performs a radar operation to sense its environment, which in this example includes an object 109. The radar operation includes transmission of a radar pulse 111 and receipt of a backscatter signal 113.

It is desired to transmit the radar pulse 111 at a time such that it will arrive at the base station 107 within the cyclic prefix (CP) of an OFDM symbol and outside the BS's assigned reception window for the OFDM symbol. The amount of time available for the transmission is therefore related to the length of the CP which varies in dependence on the SCS being used. FIG. 1B is a chart showing the relationship between SCS and CP length, as defined by the 3GPP NR standards.

FIG. 1C illustrates some of the timing aspects that are relevant to the herein-described technology. Taking the arrangement of devices as shown in FIG. 1A as an example, the base station 107 has an uplink timing configuration 115 as shown, in which each CP reception window 117 is immediately followed by an associated symbol reception window 119. In order to have each UE's uplink transmissions of CP followed by associated symbol arrive at the base station 107 within the base station's allocated CP and symbol reception windows 117, 119 the propagation delay between each UE and the base station 107 is taken into account in the form of a Timing Advance (TA) value, which specifies how far in advance of the base station's timing (as observed at the UE) the signal needs to be transmitted to arrive essentially on time. As mentioned above and discussed further below, the UE's transmissions may not perfectly align with the base station's CP and symbol reception windows 117, 119 even when TA is applied (e.g., due to errors in the TA control loop and drift that occurs in-between update occasions), and the length of the CP is large enough to account for these errors during communication. But ignoring these additional factors for the moment, it can be seen that the UE1's 103 distance from the base station 107 is greater than that of the UE2's 105. Consequently, the TA 121 of the UE1 103 is greater than the TA 123 of the UE2 105.

Given the arrangement of FIG. 1C, embodiments consistent with the invention are configured to have the UE-R's 101 radar pulses/signals 111 transmitted at a time such that, as illustrated in FIG. 1C, those signals will arrive at the base station 107 within the CP reception window 117 of an OFDM symbol and outside the reception window 119 for the OFDM symbol.

As FIG. 1C illustrates, for any given UE, placement of the radar signal 111 within the base station's CP reception window 117 is dependent, at least in part, on that UE's timing advance value. The same is true for the UE-R 101 as well, which means that a UE-R 101 operated to perform sensing during the base station's uplink CP reception window 117 can use its own TA estimate as an indication of the BS receiver-aligned CP reception window location, since the timing at the BS serves as the master timing for all UEs. The UE-R 101 can receive information from the BS to obtain knowledge of the actual BS assigned reception window.

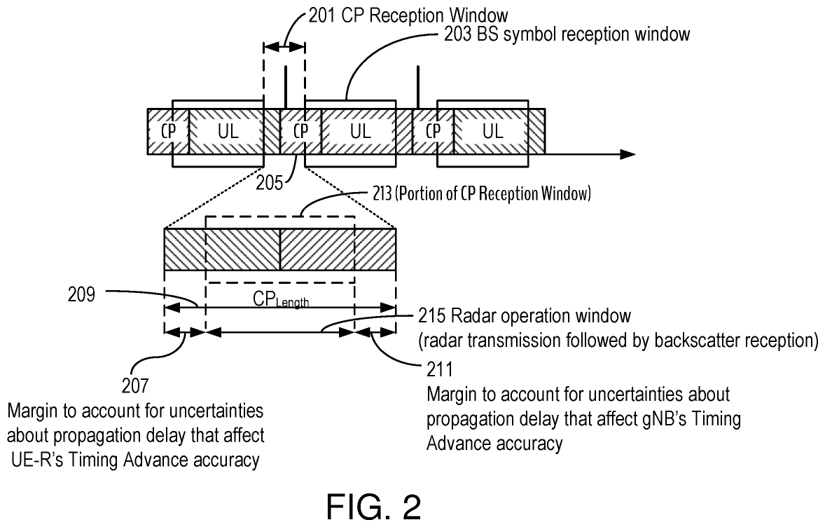

In another aspect of some but not necessarily all embodiments consistent with the invention, the technology is further configured to account for errors in timing as well as in timing advance estimates. As shown in FIG. 2, corresponding timing error margins can be applied to the radar signal timing in order to avoid overlapping with the uplink transmission of another UE. In particular, consider a BS's CP reception window 201 followed by a symbol reception window 203 (both occurring during the uplink phase of TDD operation). Due to timing estimation errors and channel characteristics the CP and symbol reception windows 201, 203 may not exactly align with the BS's ideal CP and symbol reception timing. To illustrate this point, the symbol reception window 203 includes a part of the received CP 205. Thus, the end portion of the CP 205 is actually received during a beginning part of the symbol reception window 203 and is not available for radar transmission. If the UE had transmitted a radar signal with the expectation that it would be received during an end portion of the CP reception window, that signal would then actually arrive during the beginning part of the symbol reception window 203.

It is advantageous to further provide a margin 207 at the beginning of the CP's length 209 and a margin 211 at the end of the CP's length 209 to account for uncertainties about propagation delay that affect the UE-R's TA accuracy and timing uncertainties at the UE-R 101. Avoiding transmission of the radar signal during the two margins 207 and 211 leaves a portion of the CP reception window 213 usable as a radar operation window 215 during which the radar operation (i.e., transmission of the radar signal and reception of the backscatter signal) should be performed.

Accordingly, the radar operation window 215 is, in some embodiments, advantageously designed based on the following factors:
1. The time position of the unused reception time window within a total CP duration 209 between two adjacent symbols. This depends on the known BS configured CP reception window 201.
2. The end of the unused reception time window cannot be used for radar transmission.

Further, a timing margin should be assigned to prevent having the echoes of the radar signal (i.e., the backscatter signal) go into the uplink symbol reception window 203 of the BS and for radar transmission timing (risk of being late) uncertainties. If the radar transmission power or timing uncertainty increase, the length of the radar transmission window decreases since more margin is required.
3. The beginning of the unused CP reception window 201 needs to have a margin assigned to accommodate radar transmission timing uncertainties (risk of being early).

The duration of the radar transmission window during a CP period can be formulated as:

Radar window=CP_length−Radar transmission_timing_uncertainty−multi-path delay spread threshold (of the radar)

Since the calculated margin for uplink radar sensing results in a low risk of interference at the BS and causes no interference at the UEs, the transmission power of the radar signal can be leveraged based on the margins assigned. This allows the UE-R to have a variable radar sensing range and makes it easier to detect backscattered signals. The radar transmission must not impact the BS Automatic Gain Control (AGC) for UL communication. If the AGC is digitally controlled, it could base its decisions only on the information within the symbol reception window 203, thus ignoring strong radar pulses which occur within assigned radar operation window 215.

In another aspect of some but not necessarily all embodiments consistent with the invention, a switch is introduced in the UE-R's signal path, for instance at the LNA output, with the output is shorted to produce almost no output signal when outside the symbol reception window 203. This would prevent saturation of the receiver that would otherwise occur due to strong radar pulses if the AGC has set the gain high.

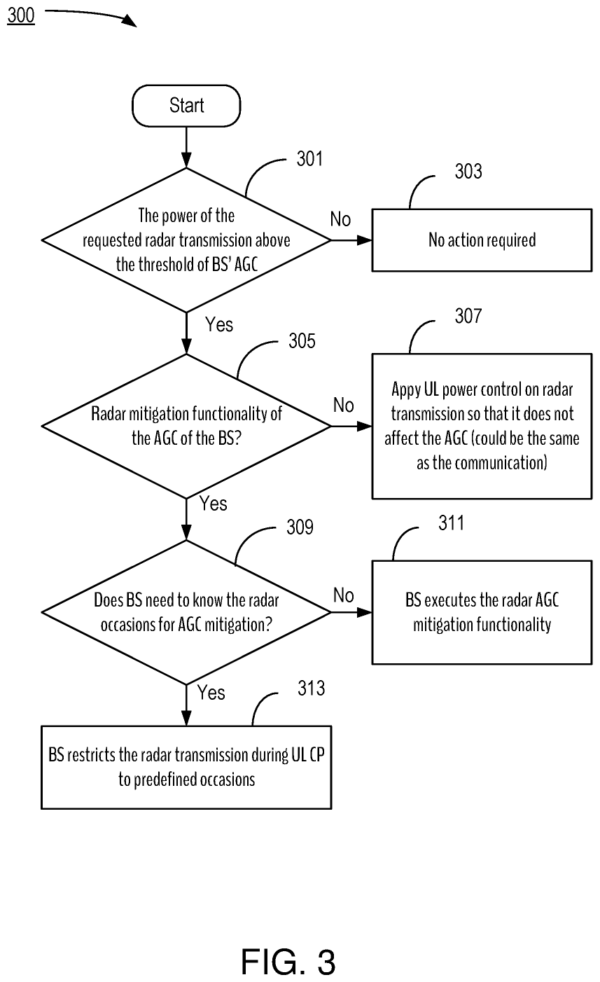

In another aspect of some but not necessarily all embodiments consistent with the invention, BS radar AGC mitigation can be a BS capability that is applied during radar transmissions in the UL CP. Such mitigation needs to be coordinated with the occurrence of radar transmission. If the BS lacks AGC mitigation capability, power control of the radar transmission may be needed (and could, for example, be based on regular communication or actual radar transmission). To illustrate these aspects, FIG. 3 is, in one respect, a flowchart of actions performed by the system in accordance with a number of embodiments. In other respects, the blocks depicted in FIG. 3 can also be considered to represent means 300 (e.g., hardwired or programmable circuitry or other processing means) for carrying out the described actions.

As shown beginning in FIG. 3, the process includes deciding whether the power of the requested radar transmission is above a predefined threshold value of the base station's AGC circuitry (decision block 301). If it is not (“No” path out of decision block 301), then no action is required (step 303).

If the power of the requested radar transmission is above the predefined threshold value of the base station's AGC circuitry (“Yes” path out of decision block 301) it is determined whether the base station has the capability of mitigating the effects of radar transmissions on the base station's AGC functionality (decision block 305). If not (“No” path out of decision block 305), then the UE-R should apply uplink power control on its radar transmissions (step 307) to prevent those transmissions from affecting the AGC functionality. The uplink power control applied to radar transmissions is, in some but not necessarily all inventive embodiments, based on power control information derived during uplink communication activity.

If the base station is capable of mitigating the affects of radar transmissions on its AGC functionality (“Yes” path out of decision block 305), then it is decided whether the base station needs to know the timing of the radar transmission occasions in order to perform the AGC mitigation (decision block 309). If such information is not required (“No” path out of decision block 309), then the base station executes the radar AGC mitigation functionality (step 311).

But if the timing of the radar transmission occasions needs to be known and applied as part of the AGC mitigation (“Yes” path out of decision block 309), then the base station decides in which one(s) of the possible radar operation windows radar transmission will be permitted to occur, and accordingly restricts the radar transmission during the uplink CP to those predefined occasions (step 313).

It can be seen that the UE-R's ability to properly configure placement of a radar operation window 215 and to avoid experiencing interference from other devices is facilitated by having information about its operating environment (e.g., distance to a base station and to other UEs in the environment, related timing of such devices, etc.). To this end, the UE-R 101 in some but not necessarily all inventive embodiments asks the network to provide information about the UL radio resources of the other UEs so that it can perform frequency filtering/matched filtering to mitigate the UL interference of the other UEs during the backscattered signal reception.

A precise placement of the radar signal within the CP period creates better margins for radar transmissions and interference avoidance. In one embodiment, a radar-enabled UE's improved timing capability increases the precision and margins of the closed-loop timing control for better radar timing at the BS receiver. Enablers for efficient radar sensing during a CP-based radar operation window 215 include:
1. A more precise timing capability for the radar-enabled UE (Rx to Tx timing) than the timing capability specified by 3GPP standardization (called “timing error limit value”, “Tₑ”) as part of the TA control loop for communication. The T e parameter relates to a UE's capability with respect to correct UL transmission timing relative a tracked DL transmission received at the UE. The parameter is expressed as a plus/minus error window within which the UE's timing error must fall. In practice, a radar-enabled UE 101 will typically have a superior relative Rx to Tx timing precision since it is an inherent property for accurate radar sensing.
2. A more precise radar-enabled UE's TA command setting accuracy than that which is specified by 3GPP standardization for communication (i.e., a UE capability).
3. Higher resolution TA command signals from the network to the radar-enabled UE device than those specified by 3GPP for communication.
4. More frequent TA commands from the network to more accurately capture channel delay variation.

A more accurate closed loop control for uplink timing allows the network to fine tune the ideal position of the received radar transmission within the CP reception window 201. The measured uplink timing can be based on measured communication in the uplink, measured timing of radar signals or both.

In some but not necessarily all inventive embodiments, the base station (e.g., gNB) can assign allowed symbols in which radar during CP is allowed. This aspect can advantageously be used to avoid the risk of interference to critical symbols like control signals or to restrict radar operation to symbols with a larger CP. The start and stop of the allowed radar operation window 215 can be derived either by the UE-R 101 or the BS 107 and can change dynamically during operation if conditions change. The accuracy of the TA value used in the TA operation depends on aspects of the BS technology (e.g., RX/UL timing measurement), TA command resolution (related to BS measurement accuracy and UE TA setting accuracy), UE tracking (RX/DL to TX/UL), and UE TA command setting accuracy. All of these are part of the TA control loop.

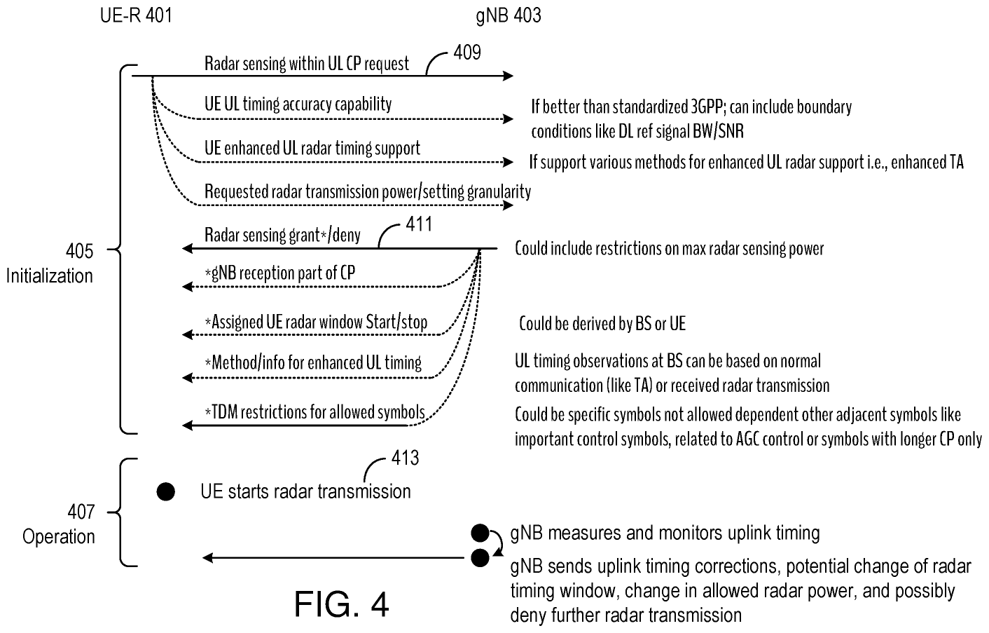

Turning now to another aspect of some but not necessarily all inventive embodiments, FIG. 4 is a signaling diagram illustrating how a UE-R 401 interacts with a base station (in this example, illustrated as the gNB 403) with respect to a radar operation. The signaling can be divided into two stages: an initialization phase 405, and an operation phase 407. The initialization phase can include the following signal exchange:
The UE-R 401 sends a request 409 to perform radar sensing within UL CP. The UE-R 401 can also send any combination (or none) of the following information to support the request:
   information about UE UL timing accuracy capability (i.e., whether the UE's UL timing accuracy is better than the standardized 3GPP performance and in relation to boundary conditions like downlink reference signal characteristics, bandwidth (BW) and/or signal-to-noise ratio (SNR)). The gNB 403 can use this and other information as a basis for determining expected timing accuracy.
   information indicating whether the UE-R 401 supports various methods for enhanced UL radar support (e.g., enhanced TA capability)
   a requested radar transmission power/setting granularity
In response to the request, the gNB 403 communicates a response 411 indicating whether the radar sensing request is granted or denied. In an aspect of some but not necessarily all inventive embodiments, the request can be granted but with restrictions on the allowable level of radar transmission power. In further aspects, the response 411 can additionally indicate any one or more (or none) of the following:
   the gNB reception part of the CP reception window 201 to be used
   the assigned start/stop times of the assigned UE radar operation window 215
   a method to be used, or other information pertaining to enhanced UL timing
   restrictions on which time division multiplexing symbols are allowed to be used for CP-based radar operations

In the operation phase 407, the UE-R 401 starts a radar transmission 413. The gNB 403 measures and monitors uplink timing 415 and improves radar performance by then communicating information to the UE-R 401 indicating any one or more of:
uplink timing corrections
a potential change of the radar operation window 215
a change in the allowed power level for radar transmissions
possible denial of further radar transmissions

In yet another aspect of some but not necessarily all inventive embodiments, different radar transmission beam directions can have individual and optimized transmission timings to fall within respective CP periods of different UEs received at different beams of the BS. The BS may use this information when granting or denying radar transmission during the uplink CP period.

In still another aspect of some but not necessarily all inventive embodiments, a radar-enabled UE may adapt its power during the radar sensing to further reduce the possibility of causing interference at the network. For example, when timing is less accurate, the UE-R can allocate less power for radar transmissions.

In yet another aspect of some but not necessarily all inventive embodiments, the radar-enabled UE may interfere with the uplink transmissions of one or more neighboring BSs (e.g., if the UE-R is close to the edge of the cell). Under such circumstances, the UE-R might also need to coordinate with the CP uplink period of some of the neighboring cell's UEs.

The discussion will now focus on another class of embodiments consistent with the invention, in which radar sensing is performed during a downlink phase of TDD operation.

Similar to using the CP period for radar transmission in uplink, a radar-enabled UE can also use the CP period of DL symbols for radar transmission. An important aspect for avoiding DL interference is to consider the CP timings at potential victim UEs when performing radar transmission. The principles for doing this are very similar to those discussed above with respect to radar operations configured to occur during the uplink phase of TDD operation. Performing radar operations during the DL phase differs from performance during the UL phase in that the CP timings that need to be considered are variable and differ across the victim UEs. Accordingly, radar transmission timing during the DL phase of TDD operation depends factors that include:
1. The downlink propagation delay from the BS towards the victim UEs.
2. The radar propagation delay between the UE-R 101 and the victim UEs.

The situation is illustrated in FIG. 5A, which depicts a UE-R 501 in a cell that also includes first and second UEs 503, 505. All three of the devices are served by a base station 507. The UE-R 501 is to transmit a radar signal 509 in order to sense its environment which, merely for purposes of illustration, include an object 511. A backscatter signal 513 is reflected off of the object 511.

As with the case of operation during the UL phase of TDD operation, in the DL phase the length of the CP depends on the subcarrier spacing. FIG. 5B is a chart showing the relationship between SCS and CP length, as defined by the 3GPP NR standards.

FIG. 5C illustrates some of the timing aspects that are relevant to the herein-described technology with respect to radar operation during the downlink phase of TDD operation. Taking the arrangement of devices as shown in FIG. 5A as an example, the base station 507 has a downlink timing configuration 515 as shown, in which each CP transmission window 517 is immediately followed by an associated symbol transmission window 519. In order to have each of the BS's downlink transmissions of CP followed by associated symbol arrive at a respective one of the first and second UEs 503, 505 within that UE's allocated CP and symbol reception windows the propagation delay between the base station 507 and each UE 503, 505 is taken into account and this RF propagation delay (521 and 523) can be estimated based on TA or more precisely its NTA/2 part, since NTA specifies how far in advance of the respective UE's timing an UL communication signal from the UE needs to be transmitted in order to arrive essentially on time within a BS's uplink symbol reception window. The reference for estimating the RF propagation delay 521, 523 is the UE's timing of receipt of tracked DL symbols. As mentioned above and discussed further below, the arrival time at the UEs of the base station's transmissions may not perfectly align with a UE's CP 525, 529 and symbol 527, 531 reception windows. In addition, although the NTA/2 is used as a DL RF propagation delay estimate, it includes errors. But ignoring these additional factors for the moment, it can be seen that the UE1's 503 distance from the base station 507 is greater than that of the UE2's 505. Consequently, the RF propagation delay 521 from the BS 507 to the UE1 503 is greater than the RF propagation delay 523 from the BS 507 to the UE2 505.

Given the arrangement of FIG. 5C, embodiments consistent with the invention are configured to have the UE-R's 501 radar pulses/signals 509 transmitted at a time such that, as illustrated in FIG. 5C, those signals will arrive at each of the first and second UEs 503, 505 within those devices' respective CP reception windows 525, 529 of an OFDM symbol and outside the respective symbol reception windows 527, 531 for the OFDM symbol.

As FIG. 5C illustrates, for any given UE, placement of the radar signal 509 within that UE's CP reception window 525, 529 is dependent, at least in part, on the propagation delay from the base station to the UE. The same is true for the UE-R 501 as well, which means that a UE-R 501 operated to perform sensing during the nearby UE's respective downlink CP reception window 525, 529 needs to obtain its own estimates of the propagation delay between itself and those other devices.

In another aspect of some but not necessarily all inventive embodiments, the radar-enabled UE 501 can derive the CP aligned radar transmission timing based on:
1. Assuming that the victim UE is nearby and has similar channel characteristics to that of the radar-enabled UE 501, the radar-enabled UE 501 can use its estimated DL RF propagation delay as the propagation delay of the victim UE 503, 505. For more than one victim UE, all of them need to satisfy the mentioned conditions, otherwise, the radar transmission will be misaligned with the CP reception periods 525, 529 and interfere with the communication signal at the UEs 503, 505.

In practice, this assumption is valid if:
a. The victim(s) is/are in close vicinity to the UE-R 501 and thereby experience(s) the same DL RF propagation delay. The planned sensing rage (i.e., the range of distances from the radar UE 501 to the victim UEs 503, 505, where its radar transmission may create interference, should be “short” in relation to the CP length.
b. The radar-enabled UE 501 controls its transmission power so that only the close-range UEs 503, 505 (i.e., those satisfying the above constraint) are affected. (Assuming the radar-enabled UE does not know about and consequently adapt to known TDM based DL scheduling, DL timing and radar propagation delays for specific UEs)
   Under this assumption, the radar-enabled UE 501 may perform radar transmissions during its local CP timing minus timing estimation margins. In some but not necessarily all inventive embodiments, these margins are a sum of the radar-enabled UE's timing error and a typical UE's assumed timing error. In one embodiment, the radar-enabled UE 501 may further consider the channel dispersion and increase the margins for larger dispersion estimates, as the OFDM symbol timing estimation is inherently less accurate. (By assuming that close UEs have similar channel properties and a short delay for the interference path).
2. Using information about propagation delay through victim's accumulated NTA (i.e., the 3GPP-defined dynamic part of TA corresponding to Round Trip Time (RTT) RF propagation delay) or, more precisely, accumulated NTA/2 as a measure of reception delay with respect to BS transmit timing. The network or the victim UEs 503, 505, using an established side link or communication via network, can provide the radar-enabled UE 501 with values for accumulated NTA/2 of the nearby victim UEs 503, 505, including information about used reception windows. The accumulated NTA only provides a range representing RF path delay to the BS, but does not indicate the UE-R's azimuth with respect to the BS, and therefore does not give any guidance regarding the actual RF path delay between the aggressor UE-R and its potential victims (e.g., UE1/UE2), nor does it indicate the potential pathloss that can mitigate interference. The network can assist in this respect by providing further information about close proximity UEs (e.g., through spatial information from beam forming (Angle of Arrive—“AoA”), such as positioning data of these devices) that can be used by the UE-R 501 to filter out and limit candidate victim UEs related to radar power levels used.

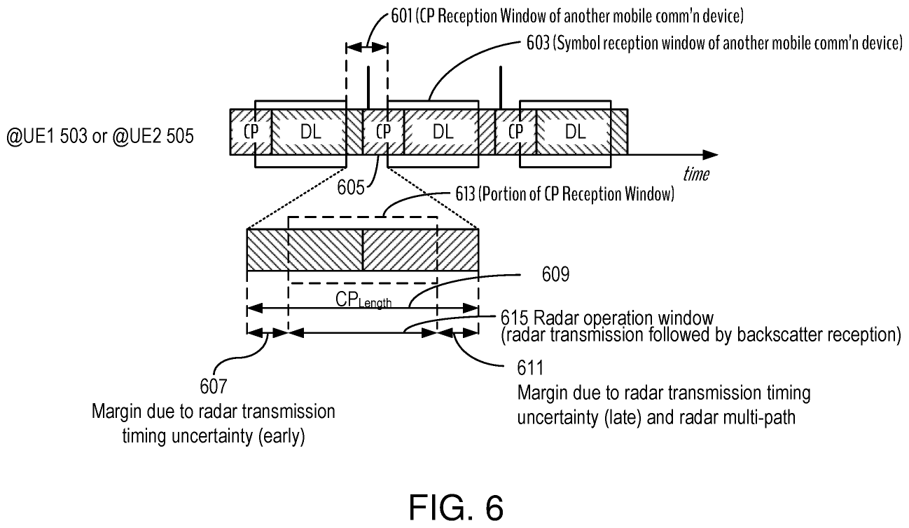

The above-described aspects are illustrated in FIG. 6, which is a timing diagram showing how corresponding timing error margins can be applied to the radar signal timing in order to avoid overlapping with the downlink transmission of the base station 507 when received by another UE 503, 505. In particular, consider a UE's (e.g., UE1 503 or UE2 505) CP reception window 601 followed by a symbol reception window 603 (both occurring during the downlink phase of TDD operation). Due to timing estimation errors and channel characteristics, the CP and symbol reception windows 601, 603 may not exactly align with the ideal CP and symbol reception timing. To illustrate this point, the symbol reception window 603 includes a part of the received CP 605. Thus, the end portion of the CP 605 is actually received during a beginning part of the symbol reception window 603 and is not available for radar transmission. If the UE-R 501 had transmitted a radar signal with the expectation that it would be received during an end portion of the CP reception window, that signal would then actually arrive during the beginning part of the symbol reception window 603 if the UE-R's estimation of the propagation delay between itself and the other UE were too low.

Therefore, it is advantageous to further provide a margin 607 at the beginning and end of the CP's length 609 to account for uncertainties about the victim UE's symbol reception window (603) relative to the UE-R's DL timings and uncertainties about the propagation delay estimates between the UE-R and a victim that could otherwise cause radar-related interference to occur within a victim UE's symbol reception windows. The margin 611 can be reduced in some embodiments by taking into account that radar transmission (which is the source of the interference) occurs in a beginning part of the radar operation window 615 (at least for pulse based radar). Avoiding transmission of the radar signal during the two margins 607 and 611 leaves a portion 613 of the CP reception window 601 usable as a radar operation window 615 during which the radar operation (i.e., transmission of the radar signal and reception of the backscatter signal) should be performed.

In another aspect of some but not necessarily all inventive embodiments, different beams of the radar-enabled UE 501 may face different victim UEs, hence, the radar transmission of each beam can be individually tuned to align with the DL CP period of the corresponding victim UEs. For example, the radar-enabled UE may choose to sense through a specific beam that observes a group of close UEs, which are likely to have a similar channel condition.

In yet another aspect of some but not necessarily all inventive embodiments, DL transmissions from the network to the other UEs may affect the backscattered signal reception of the radar-enabled UE 501 when it sends radar signals during a DL CP period. The radar-enabled UE 501 may choose to operate the radar only when the radar range is below a threshold, so the backscattered signal will have a sufficient SNR for detection.

The discussion will now focus on sensing period selection. Radar sensing within a CP period during uplink or downlink phases of TDD depends on the operation mode of the radar-enabled UE 101, 501. Since more accurate CP timing at the radar-enabled UE is possible during the uplink phase of TDD operation, the radar-enabled UE 101, 501 can use the UL phases for longer range surveillance compared to DL phases, and it can use DL phases for relatively shorter sensing range (e.g., high resolution close objects). Also, the UE-R 101, 501 can combine information from sensing in both the UL and DL phases for more flexibility.

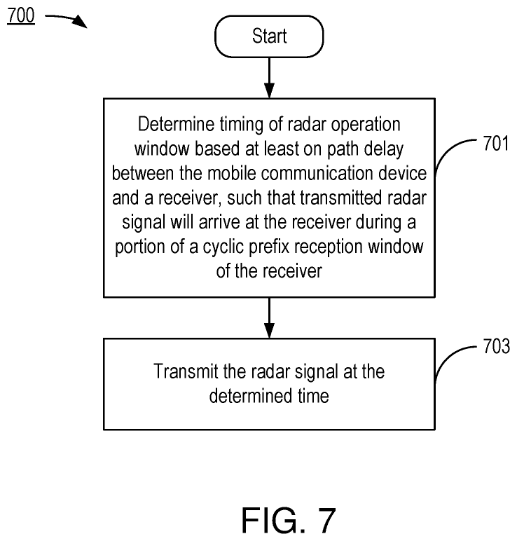

To facilitate a further understanding of aspects of some but not necessarily all inventive embodiments, these are illustrated in FIG. 7, which is, in one respect, a flowchart of actions performed by a UE-R 101, 501 in accordance with a number of embodiments. In other respects, the blocks depicted in FIG. 7 can also be considered to represent means 1500 (e.g., hardwired or programmable circuitry or other processing means) for carrying out the described actions.

As shown in FIG. 7, a process is illustrated that performs a radar sensing function in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction. Another aspect of the air interface is that each transmitted symbol from a plurality of transmitted symbols has a corresponding cyclic prefix that is transmitted immediately before the corresponding transmitted symbol, and that is a repetition of an end part of the corresponding transmitted symbol. Cyclic prefixes are well-known in the art and need not be described here further.

Actions included in the process include using information about a path delay between the mobile communication device and a receiver as one of one or more bases to determine a timing of a radar operation window comprising a radar signal transmission time and a radar backscatter reception period (step 701), wherein the determined timing of the radar operation window is configured to cause the radar signal, when transmitted from the mobile communication device at the determined radar signal transmission time, to arrive at the receiver during a portion of a cyclic prefix reception window of the receiver. The radar signal is then transmitted at the determined time (step 703).

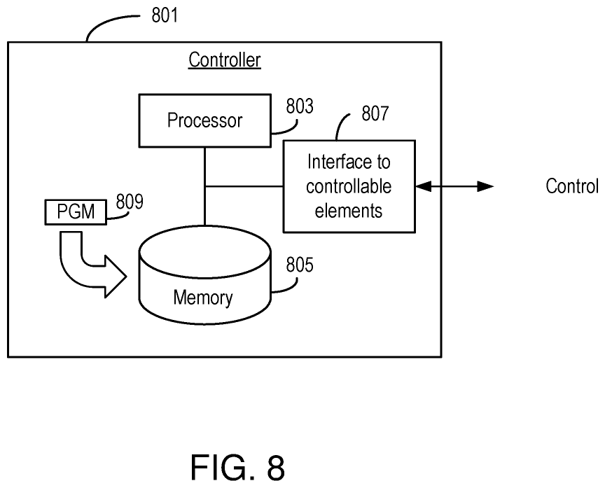

Aspects of an exemplary controller 801 that may be included in a radar-capable mobile communication device 800 to cause any and/or all of the above-described actions to be performed as discussed in the various embodiments are shown in FIG. 8, which illustrates an exemplary controller 801 of a mobile communication device 800 in accordance with some but not necessarily all exemplary embodiments consistent with the invention. In particular, the controller 801 includes circuitry configured to carry out any one or any combination of the various functions described above. Such circuitry could, for example, be entirely hard-wired circuitry (e.g., one or more Application Specific Integrated Circuits—“ASICs”). Depicted in the exemplary embodiment of FIG. 8, however, is programmable circuitry, comprising a processor 803 coupled to one or more memory devices 805 (e.g., Random Access Memory, Magnetic Disc Drives, Optical Disk Drives, Read Only Memory, etc.) and to an interface 807 that enables bidirectional communication with other elements of the mobile communication device 800. The memory device(s) 805 store program means 809 (e.g., a set of processor instructions) configured to cause the processor 803 to control other system elements so as to carry out any of the aspects described above. The memory device(s) 805 may also store data (not shown) representing various constant and variable parameters as may be needed by the processor 803 and/or as may be generated when carrying out its functions such as those specified by the program means 809.

It will be understood from this description and accompanying figures that an aspect of described embodiments includes a radar-enabled UE transmitting radar signals so they will line up with cyclic prefix reception windows of potential victim receivers in order to avoid interference between the mmWave radar sensing and mmWave 5G communication. The principle is applicable during uplink as well as downlink phases of TDD operation.

The technology provides advantages over conventional technology at least in that it provides a way to perform resource efficient radar sensing via the unused period of the uplink/downlink cyclic prefix so that a UE can perform radar sensing without interfering with the communication function of other UEs and of the base station.

The invention has been described with reference to particular embodiments. However, it will be readily apparent to those skilled in the art that it is possible to embody the invention in specific forms other than those of the embodiment described above. Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of performing a radar sensing function in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction, and in which each transmitted symbol from a plurality of transmitted symbols has a corresponding cyclic prefix that is transmitted immediately before the corresponding transmitted symbol, and that is a repetition of an end part of the corresponding transmitted symbol, the method comprising:
using information about a path delay between the mobile communication device and a receiver as one of one or more bases to determine a timing of a radar operation window having a duration that is shorter than a duration of a cyclic reception window of the receiver and comprising a radar signal transmission time and a radar backscatter reception period, wherein the determined timing of the radar operation window is configured to cause the radar signal, when transmitted from the mobile communication device at the determined radar signal transmission time, to arrive at the receiver during a portion of the cyclic prefix reception window of the receiver; and
transmitting the radar signal at the determined radar signal transmission time.

2. The method of claim 1, wherein determining the timing of the radar operation window comprises:
using an uncertainty associated with the information about the path delay as one of the bases to determine the timing of the radar operation window.

3. The method of claim 2, comprising:
adjusting a transmission power of the radar signal based on a radar transmission timing uncertainty.

4. The method of claim 1, wherein determining the timing of the radar operation window comprises:
using an uncertainty associated with a placement of the cyclic prefix reception window of the receiver or of a symbol reception window of the receiver.

5. The method of claim 1, wherein determining the timing of the radar operation window comprises:
using information about a level of multi-path delay spread experienced at the receiver as one of the bases to determine the timing of the radar operation window.

6. The method of claim 4, comprising:
adjusting a transmission power of the radar signal based on the level of radar signal multi-path delay spread at the receiver.

7. The method of claim 1, wherein the receiver is a network node receiver and the determined time causes the transmitted radar signal to arrive during the portion of the cyclic prefix reception window of the network node receiver.

8. The method of claim 1, comprising:
detecting that a power level to be applied when transmitting the radar signal is above a threshold power level associated with an automatic gain control process of the receiver, and in response to the detecting, performing one or more mitigating actions to mitigate an effect that transmitting the radar signal would have on the automatic gain control process of the receiver.

9. The method of claim 1, wherein determining the timing of the radar operation window comprises:
obtaining information about a timing of a symbol reception window at the receiver; and
deriving the timing of the radar operation window and a length of the radar operation window from the received information about the timing of the symbol reception window at the receiver and one or more values of timing uncertainty about a beginning portion of the cyclic prefix reception window of the receiver and an end portion of the cyclic prefix reception window of the receiver.

10. The method of claim 1, comprising:
using network-provided information about radio resources of one or more other mobile communication devices to determine a radar signal filter that will mitigate interference from the one or more other mobile communication devices when a backscatter signal of the radar signal is received.

11. The method of claim 1, comprising:
reporting a mobile communication device timing capability level to a network node.

12. The method of claim 1, comprising:
determining a length of the radar operation window in proportion to a level of timing accuracy of the mobile communication device.

13. The method of claim 1, wherein the receiver is a receiver of another mobile communication device and the determined time causes the transmitted radar signal to arrive during the portion of the cyclic prefix reception window of said another mobile communication device.

14. The method of claim 13, comprising:
using a value of downlink propagation delay from a network node to said another mobile communication device and a value of radar propagation delay between the mobile communication device and said another mobile communication device as at least two bases to determine the timing of the radar operation window.

15. The method of claim 14, comprising:
using a level of radar signal transmission power as one of said bases to determine the timing of the radar operation window.

16. The method of claim 13, comprising:
adjusting a transmission power level of the transmitted radar signal in dependence on a radar propagation delay between the mobile communication device and said another mobile communication device.

17. The method of claim 14, comprising:
using a value of downlink propagation delay from the network node to the mobile communication device as the value of downlink propagation delay from the network node to said another mobile communication device.

18. The method of claim 14, comprising:
obtaining the value of downlink propagation delay from the network node to said another mobile communication device from said another mobile communication device.

19. The method of claim 14, comprising:
obtaining the value of downlink propagation delay from the network node to said another mobile communication device from the network node.

20. The method of claim 13, comprising:
tuning a direction of a transmission beam based on a timing of a downlink cyclic prefix period of said another mobile communication device.

21. The method of claim 1, wherein determining the timing of the radar operation window comprises:
selecting a cyclic prefix transmission window of a symbol transmitted by a network node during one of the downlink time slots when a radar surveillance range is below a predetermined distance threshold; and
selecting a cyclic prefix reception window of a symbol received by the network node during one of the uplink time slots when the radar surveillance range is above the predetermined distance threshold.

22. The method of claim 1, comprising:
receiving an instruction from a network node that prohibits performance of a radar operation.

23. A non-transitory computer readable storage medium comprising instructions that, when executed by at least one processor, causes the at least one processor to carry out a method of performing a radar sensing function in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction, and in which each transmitted symbol from a plurality of transmitted symbols has a corresponding cyclic prefix that is transmitted immediately before the corresponding transmitted symbol, and that is a repetition of an end part of the corresponding transmitted symbol, wherein the method comprises:
using information about a path delay between the mobile communication device and a receiver as one of one or more bases to determine a timing of a radar operation window having a duration that is shorter than a duration of a cyclic reception window of the receiver and comprising a radar signal transmission time and a radar backscatter reception period, wherein the determined timing of the radar operation window is configured to cause the radar signal, when transmitted from the mobile communication device at the determined radar signal transmission time, to arrive at the receiver during a portion of the cyclic prefix reception window of the receiver; and
transmitting the radar signal at the determined radar signal transmission time.

24. (canceled)

25. An apparatus configured for performing a radar sensing function in a mobile communication device that operates in a Time Division Duplex (TDD) wireless communication system having an air interface that comprises a plurality of uplink symbol times associated with symbols transmitted in an uplink direction and a plurality of downlink symbol times associated with symbols transmitted in a downlink direction, and in which each transmitted symbol from a plurality of transmitted symbols has a corresponding cyclic prefix that is transmitted immediately before the corresponding transmitted symbol, and that is a repetition of an end part of the corresponding transmitted symbol, the apparatus configured to:
use information about a path delay between the mobile communication device and a receiver as one of one or more bases to determine a timing of a radar operation window having a duration that is shorter than a duration of a cyclic reception window of the receiver and comprising a radar signal transmission time and a radar backscatter reception period, wherein the determined timing of the radar operation window is configured to cause the radar signal, when transmitted from the mobile communication device at the determined radar signal transmission time, to arrive at the receiver during a portion of the cyclic prefix reception window of the receiver; and
transmit the radar signal at the determined radar signal transmission time.

26. The apparatus of claim 25, wherein determining the timing of the radar operation window comprises:
using an uncertainty associated with the information about the path delay as one of the bases to determine the timing of the radar operation window.

27. The apparatus of claim 26, wherein the apparatus is further configured to:
adjust a transmission power of the radar signal based on a radar transmission timing uncertainty.

28. The apparatus of claim 25, wherein determining the timing of the radar operation window comprises:
using an uncertainty associated with a placement of the cyclic prefix reception window of the receiver or of a symbol reception window of the receiver.

29. The apparatus of claim 25, wherein determining the timing of the radar operation window comprises:
using information about a level of multi-path delay spread experienced at the receiver as one of the bases to determine the timing of the radar operation window.

30. The apparatus of claim 28, wherein the apparatus is further configured to:
adjust a transmission power of the radar signal based on the level of radar signal multi-path delay spread at the receiver.

31. The apparatus of claim 25, wherein the receiver is a network node receiver and the determined time causes the transmitted radar signal to arrive during the portion of the cyclic prefix reception window of the network node receiver.

32. The apparatus of claim 25, wherein the apparatus is configured to:
detect that a power level to be applied when transmitting the radar signal is above a threshold power level associated with an automatic gain control process of the receiver, and in response to the detecting, performing one or more mitigating actions to mitigate an effect that transmitting the radar signal would have on the automatic gain control process of the receiver.

33. The apparatus of claim 25, wherein determining the timing of the radar operation window comprises:
obtaining information about a timing of a symbol reception window at the receiver; and
deriving the timing of the radar operation window and a length of the radar operation window from the received information about the timing of the symbol reception window at the receiver and one or more values of timing uncertainty about a beginning portion of the cyclic prefix reception window of the receiver and an end portion of the cyclic prefix reception window of the receiver.

34. The apparatus of claim 25, wherein the apparatus is configured to:
use network-provided information about radio resources of one or more other mobile communication devices to determine a radar signal filter that will mitigate interference from the one or more other mobile communication devices when a backscatter signal of the radar signal is received.

35. The apparatus of claim 25, wherein the apparatus is configured to:
report a mobile communication device timing capability level to a network node.

36. The apparatus of claim 25, wherein the apparatus is configured to:
determine a length of the radar operation window in proportion to a level of timing accuracy of the mobile communication device.

37. The apparatus of claim 25, wherein the receiver is a receiver of another mobile communication device and the determined time causes the transmitted radar signal to arrive during the portion of the cyclic prefix reception window of said another mobile communication device.

38. The apparatus of claim 37, wherein the apparatus is configured to:
use a value of downlink propagation delay from a network node to said another mobile communication device and a value of radar propagation delay between the mobile communication device and said another mobile communication device as at least two bases to determine the timing of the radar operation window.

39. The apparatus of claim 38, wherein the apparatus is configured to:
use a level of radar signal transmission power as one of said bases to determine the timing of the radar operation window.

40. The apparatus of claim 37, wherein the apparatus is configured to:
adjust a transmission power level of the transmitted radar signal in dependence on a radar propagation delay between the mobile communication device and said another mobile communication device.

41. The apparatus of claim 38, wherein the apparatus is configured to:
use a value of downlink propagation delay from the network node to the mobile communication device as the value of downlink propagation delay from the network node to said another mobile communication device.

42. The apparatus of claim 38, wherein the apparatus is configured to:
obtain the value of downlink propagation delay from the network node to said another mobile communication device from said another mobile communication device.

43. The apparatus of claim 38, wherein the apparatus is configured to:
obtain the value of downlink propagation delay from the network node to said another mobile communication device from the network node.

44. The apparatus of claim 37, wherein the apparatus is configured to:
tune a direction of a transmission beam based on a timing of a downlink cyclic prefix period of said another mobile communication device.

45. The apparatus of claim 25, wherein determining the timing of the radar operation window comprises:
selecting a cyclic prefix transmission window of a symbol transmitted by a network node during one of the downlink time slots when a radar surveillance range is below a predetermined distance threshold; and
selecting a cyclic prefix reception window of a symbol received by the network node during one of the uplink time slots when the radar surveillance range is above the predetermined distance threshold.

46. The apparatus of claim 25, wherein the apparatus is configured to:
receive an instruction from a network node that prohibits performance of a radar operation.
